(19) United States
(12) Patent Application Publication
(10) Pub. No.: US 2024/0402296 A1
(43) Pub. Date: Dec. 5, 2024

(54) SYSTEM AND METHOD FOR TESTING RADAR DEVICE WITHIN LARGE TEMPERATURE RANGES

(71) Applicant: VAYYAR IMAGING LTD., Yehud (IL)

(72) Inventors: Miroslav BARYAKH, Rosh HaAyin (IL); Naftali CHAYAT, Kfar Saba (IL)

(21) Appl. No.: 18/701,231

(22) PCT Filed: Oct. 13, 2022
(86) PCT No.: PCT/IB2022/059812

§ 371 Date: Apr. 14, 2024

Related U.S. Application Data
(60) Provisional application No. 63/255,447, filed on Oct. 14, 2021.

(51) Int. Cl. G01S 7/40

(52) U.S. Cl. CPC G01S 7/4086

(57) ABSTRACT

Testers for radar sensors within large temperature ranges include thermally isolated DUT chambers and target zones. Partition units separate the DUT chamber from the target zone and are constructed from thermally insulating material that is transparent to radiation generated by the radar device under test. For example, where appropriate the partition unit may comprise at least one layer having radio frequency transparency of between 1.02 and 1.10. Also for example, the partition unit may comprise at least one layer having thermal conductivity between 25 milliwatts per millikelvin and 35 milliwatts per millikelvin. According to some embodiments, the DUT chamber comprises a thermal chamber operable to maintain ambient temperatures between −40 Celsius and +125 Celsius.

### FIELD OF THE INVENTION

The disclosure herein relates to systems and methods for testing the operation of radar sensing devices at extreme ambient temperatures.

### BACKGROUND

Radar devices used in automotive navigation, particularly for autonomous vehicles, are required to comply with exacting standards. For example, radar devices are required to operate accurately providing imaging at high resolution under large ambient temperature ranges, possibly from minus 40 Celsius to over 125 Celsius.

In order to test such devices, it is necessary to operate them in temperature-controlled environments. The radar devices to be tested may themselves be quite small, say about 15 centimeters by 15 centimeters by 5 centimeters or even smaller. However, in order to test far field distance a much greater distance is required of up to many meters. The costs of a temperature chamber on this scale may be prohibitively expensive.

The need remains, therefore, for a small scale temperature testing system for radar detectors. The invention described herein addresses the above-described needs.

### SUMMARY OF THE EMBODIMENTS

According to one aspect of the presently disclosed subject matter a system is introduced for testing radar sensors within large temperature ranges. The system may include a DUT chamber for accommodating a radar device under test (DUT); a target zone for accommodating a test target; and a partition unit for dividing the DUT chamber from the target zone.

The partition unit typically comprises a thermally insulating material that is transparent to radiation generated by the radar device under test. For example, where appropriate the partition unit may comprise at least one layer having radio frequency transparency of between 1.02 and 1.10. Also for example, the partition unit may comprises at least one layer having thermal conductivity between 25 milliwatts per millikelvin and 35 milliwatts per millikelvin.

In various examples, the partition unit comprises a first plastic layer, a second plastic layer and a thermal insulating radio frequency window sandwiched between the first plastic layer and the second plastic layer.

Where appropriate, the partition unit comprises a foam closed-cell material. For example, the foam closed-cell material may be selected from a group comprising polystyrene foam, Rohacell™ and the like as well as combinations thereof.

Optionally, the partition unit has a radome thickness much lower than the radar's transmission wavelength. Optionally, the partition unit has a radome thickness or half the radar's transmission wavelength.

Where appropriate, the partition unit comprises multiple antireflective layers. For example, a first quarterwave radome lining layer, a second quarterwave radome lining layer and a radome foam layer sandwiched between the first quarterwave radome lining layer and the second quarterwave radome lining layer.

Additionally, the partition unit may comprise a planar thermally isolating radome window. Alternatively, the partition unit may comprise a dome-shaped thermally isolating radome window.

In some examples, the target zone comprises a closed chamber. Alternatively, the target zone comprises an open-air zone for outdoor testing.

Where appropriate, the system may include a condensation prevention unit operable to prevent condensation forming on the partition unit. For example, the condensation prevention unit comprises a heating element configured to warm the partition unit. Optionally, the condensation prevention unit comprises two concentric shells, between which a stream of hot air is introduced.

According to some embodiments, the DUT chamber comprises a thermal chamber operable to maintain ambient temperatures between −40 Celsius and +125 Celsius. Where appropriate, the DUT chamber comprises a thermal chamber and an openable lid wherein, when in an open configuration, the lid is removed providing access to the thermal chamber; and, when in a closed configuration, the lid presses against thermally resistant silicon pads.

Optionally, the thermal chamber is fluidly coupled to a thermal machine operable to cool or heat a temperature regulation fluid and to provide a stream of the temperature regulation fluid through the thermal chamber. Optionally, the temperature regulation fluid comprises air.

Variously, the stream of temperature regulation fluid is provided by thermosyphonic action. Additionally or alternatively, the thermal machine may further include a fluid pump and the stream of temperature regulation fluid is provided by pump action.

Optionally, the target zone comprises a chamber with inner walls lined with radio frequency absorbers. Variously, the test target may comprise a corner reflector or a point target.

### BRIEF DESCRIPTION OF THE FIGURES

For a better understanding of the embodiments and to show how it may be carried into effect, reference will now be made, purely by way of example, to the accompanying drawings.

With specific reference now to the drawings in detail, it is stressed that the particulars shown are by way of example and for purposes of illustrative discussion of selected embodiments only, and are presented in the cause of providing what is believed to be the most useful and readily understood description of the principles and conceptual aspects. In this regard, no attempt is made to show structural details in more detail than is necessary for a fundamental understanding; the description taken with the drawings making apparent to those skilled in the art how the various selected embodiments may be put into practice. In the accompanying drawings:

FIG. 1 schematically represents a system for testing radar sensors at a range of ambient temperatures;

FIG. 2 schematically represents another embodiment of the system for testing radar sensors.

FIGS. 3A-D schematically represents a variety of structures for enclosing the system under test.

### DETAILED DESCRIPTION OF THE EMBODIMENT

Aspects of the present disclosure relate to systems and methods for testing the operation of sensing devices. In particular, the disclosure relates to a device testing system for testing radar sensors at extreme ambient temperatures.

The system may be operable to test the image quality of radar sensors under controlled laboratory conditions at required various temperatures. Embodiments of the testing system may be scaled or otherwise adapted to suit various required ranges of the sensors. Where appropriate, embodiments of the system may provide thermal chambers which may be readily movable and/or retrofittable to existing testing platforms as required.

As required, detailed embodiments of the present invention are disclosed herein; however, it is to be understood that the disclosed embodiments are merely examples of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

As appropriate, in various embodiments of the disclosure, one or more tasks as described herein may be performed by a data processor, such as a computing platform or distributed computing system for executing a plurality of instructions. Optionally, the data processor includes or accesses a volatile memory for storing instructions, data or the like. Additionally or alternatively, the data processor may access a non-volatile storage, for example, a magnetic hard disk, flash-drive, removable media or the like, for storing 10 instructions and/or data.

It is particularly noted that the systems and methods of the disclosure herein may not be limited in its application to the details of construction and the arrangement of the components or methods set forth in the description or illustrated in the drawings and examples. The systems and methods of the disclosure may be capable of other embodiments, or of being practiced and carried out in various ways and technologies.

Alternative methods and materials similar or equivalent to those described herein may be used in the practice or testing of embodiments of the disclosure. Nevertheless, particular methods and materials described herein for illustrative purposes only. The materials, methods, and examples not intended to be necessarily limiting. Accordingly, various embodiments may omit, substitute, or add various procedures or components as appropriate. For instance, the methods may be performed in an order different from described, and that various steps may be added, omitted or combined. In addition, aspects and components described with respect to certain embodiments may be combined in various other embodiments.

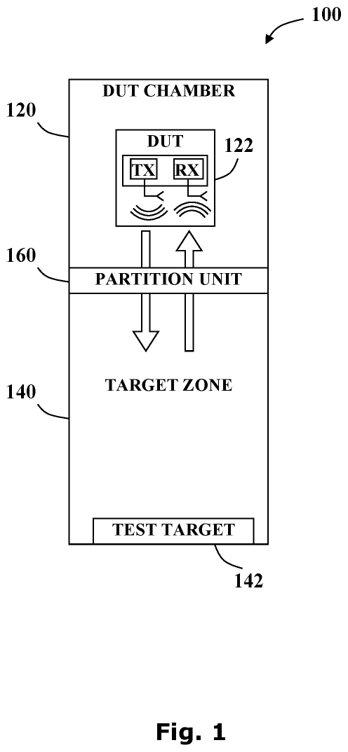

Referring now to FIG. 1, which schematically illustrates selected components of a possible example system 100 for testing radar sensors. The system 100 comprises a DUT chamber 120, a target zone 140 and a partition unit 160.

The DUT chamber 120 is a compartment into which a device under test (DUT) 122, such as a radar sensing device, may be introduced for testing. It is a particular feature of embodiment so the system 100 that the DUT chamber 120 may be a thermal control chamber including a thermally insulated compartment containing an environment maintained at a required ambient temperature.

The target zone 140, in which a test target 142 may be placed, is a region separated and isolated from the DUT chamber 120, typically an isolated chamber, although alternatively an open zone may providing an extended region.

The partition unit 160 is provided to separate the DUT chamber 120 from the target zone 140.

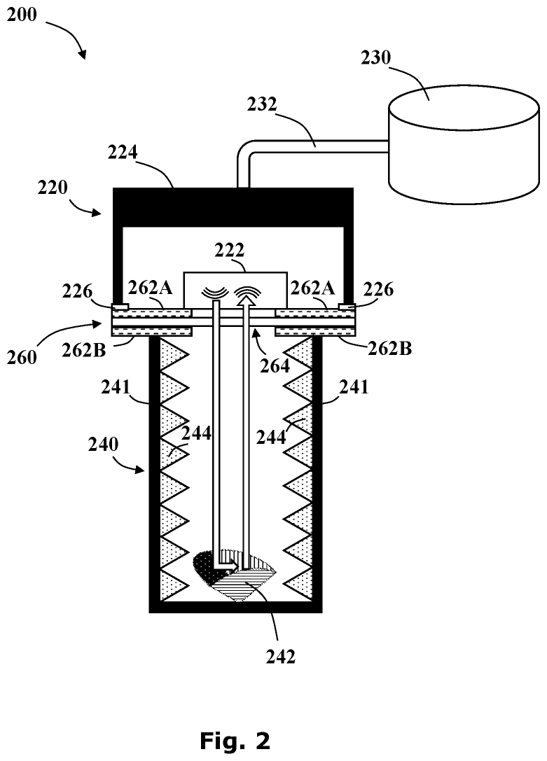

By way of example, a further embodiment of the system 200 is illustrated in FIG. 2, the thermal chamber 240 may consist of a dome lid 224 pressed against a thermally resistant silicon pads 226. The thermal chamber may be fluidly coupled via a connecting tube 232 to a thermal machine 230 operable to cool or heat a fluid, typically air, which may be made to flow towards the thermal chamber by pump action or thermosyphonically as appropriate.

The target chamber 240 contains a space into which a test target 242, such as a corner reflector, may be placed at a required range to be imaged by the DUT 222 in the thermal control chamber. It is noted that because the target chamber may be maintained at room temperature, the walls 241 of the target chamber 240 do not need to be thermally isolated from the environment.

It is a feature of examples of the target chamber 240 that the inner walls may be lined with radio frequency absorbers 244 so that reflected signals from the walls of the chamber are reduced to energy levels no greater than background noise.

The test target 242 placed within the target chamber 240 may be a corner reflector or point target placed at a required distance for testing the quality of the image generated.

The partition unit 260 is provided to divide the thermal control chamber 220 from the target chamber 240. It is a first feature of the partition unit 260 that it is thermally insulating such that the ambient temperature of the thermal control chamber 220 may be controlled independently from the test chamber 240. It is a second feature of the partition unit 260 that it is transparent to the radiation generated by the DUT 222 such that targets placed within the test chamber 240 may be imaged by the DUT 222.

The partition unit 260 may comprise a thermal insulating radio frequency window layer 264 sandwiched between two plastic layers 262A, 262B with high temperature stability. It has been found that a layer 260 having a low thermal conductivity of around 30 milliwatts per millikelvin and also a good radio frequency transparency (Dk=1.04) may be suitable for allowing the testing of a radar chip while maintaining an ambient temperature of between-40 to +125 Celsius in the thermal chamber 240.

Materials well suited for this purpose are foam closed-cell materials—the gas entrapped in the cells reduces the thermal conductivity, as well as reduces the effective dielectric constant. The simplest such material is polystyrene foam, but it is not well suited for high temperature operation. Other materials, such as Rohacell™ type of materials may serve the need.

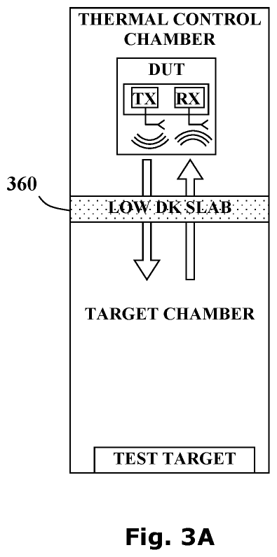

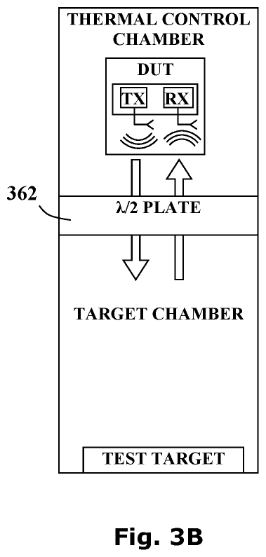

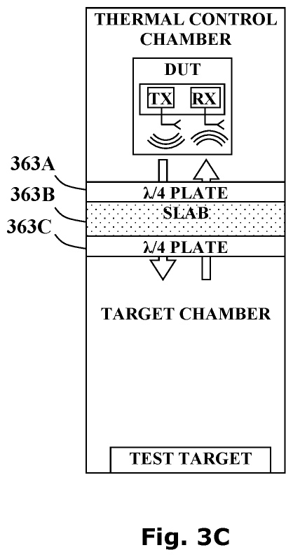

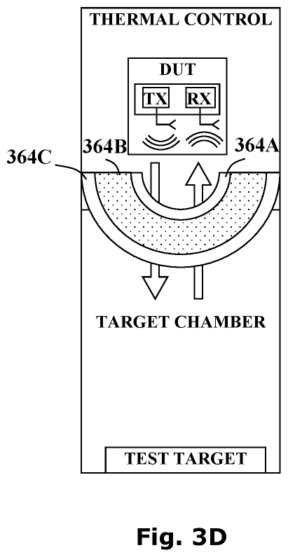

Reflection from a boundary between dielectric materials (for perpendicular incidence) is ((n₁−n₀)/(n₁+n₀))², where n=√Dₖ, therefore in order to reduce reflection the use of materials with low-Dₖ values may be preferred. FIG. 3A illustrates such planar slab 361 made of low-Dₖ material.

To improve the reflection even further, the window radome thickness can be kept low relative to the wavelength. Alternatively, as illustrated in FIG. 3B, a half-wave plate 362 may be used with a thickness at the order of half-wavelength. Still another technique is illustrated in FIG. 3C, in which a stratified window includes multiple antireflective layers, e.g. lining a radome, e.g., Dₖ=1.08 foam slab 363B with a quarterwave matching layer made of intermediate, e.g. Dₖ=1.04, foam on both sides 363A, 363C, to avoid overly thin radome. It is particularly noted that such techniques may be particularly suited for millimeter-wave radars.

The window may have a planar shape, ensuring minimal distortion of the planewaves used by the radar. However, for wide field-of-view radars, dome-shaped thermally isolating radome 364A, 364B, 364C might be preferable, as illustrated in FIG. 3D. The thickness selection and anti-reflection matching techniques are applicable to curved radomes as well as to the planar versions. Any other shape can be used, as long as electromagnetic transparency over the range of incidence angles of interest is assured.

The thermally isolated radar test system is described above in the context of a test chamber. It should be clear to the skilled in the art that this arrangement can be further used for outdoor testing of radars system (effectively an open-air test chamber). For example radar based drone detection system can be tested for extreme temperature conditions, or a vehicular radar can be tested while driving, by putting both the radar under test and the temperature control equipment on a vehicle.

The invention is described in the context of testing a radar, which is a transmit-receive system. However, it can be used with a transmitting system or a receiving system, such as a direction finding system. It can be used with a transmit-receive equipment other than radars, e.g. point-to-point communication link or acellular pico-base station.

The invention is described in the context of temperature testing, however additional parameters can be controlled within a chamber. For example, the air in the chamber can be dehydrated to avoid condensation, or have a controlled humidity that is introduced by appropriate environmental control equipment.

The radome can have means to prevent wetting or condensation. For example, the radome can be heated. Exemplary embodiment can consist of two concentric shells, between which hot air is introduced.

Technical and scientific terms used herein should have the same meaning as commonly understood by one of ordinary skill in the art to which the disclosure pertains. Nevertheless, it is expected that during the life of a patent maturing from this application many relevant systems and methods will be developed. Accordingly, the scope of the terms such as computing unit, network, display, memory, server and the like are intended to include all such new technologies a priori.

As used herein the term “about” refers to at least +10%.

The terms “comprises”, “comprising”, “includes”, “including”, “having” and their conjugates mean “including but not limited to” and indicate that the components listed are included, but not generally to the exclusion of other components. Such terms encompass the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” may include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments or to exclude the incorporation of features from other embodiments.

The word “optionally” is used herein to mean “is provided in some embodiments and not provided in other embodiments”. Any particular embodiment of the disclosure may include a plurality of “optional” features unless such features conflict.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween. It should be understood, therefore, that the description in range format is merely for convenience and brevity and should not be construed as an inflexible limitation on the scope of the disclosure. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6 as well as non-integral intermediate values. This applies regardless of the breadth of the range.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments unless the embodiment is inoperative without those elements.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present disclosure. To the extent that section headings are used, they should not be construed as necessarily limiting.

The scope of the disclosed subject matter is defined by the appended claims and includes both combinations and sub combinations of the various features described hereinabove as well as variations and modifications thereof, which would occur to persons skilled in the art upon reading the foregoing description.

1. A system for testing radar sensors within large temperature ranges comprising:
a DUT chamber for accommodating a radar device under test (DUT);
a target zone for accommodating a test target; and
a partition unit for dividing the DUT chamber from the target zone;
wherein:
the partition unit comprises a thermally insulating material that is transparent to radiation generated by the radar device under test.

2. The system of claim 1 wherein the partition unit comprises at least one layer having radio frequency transparency of between 1.02 and 1.10.

3. The system of claim 1 wherein the partition unit comprises at least one layer having thermal conductivity between 25 milliwatts per millikelvin and 35 milliwatts per millikelvin.

4. The system of claim 1 wherein the partition unit comprises a first plastic layer, a second plastic layer and a thermal insulating radio frequency window sandwiched between the first plastic layer and the second plastic layer.

5. The system of claim 1 wherein the partition unit comprises a foam closed-cell material.

6-7. (canceled)

8. The system of claim 1 wherein the partition unit has a radome thickness or half the radar's transmission wavelength.

9. The system of claim 1 wherein the partition unit comprises multiple antireflective layers.

10. The system of claim 9 wherein the multiple antireflective layers comprises a first quarterwave radome lining layer, a second quarterwave radome lining layer and a radome foam layer sandwiched between the first quarterwave radome lining layer and the second quarterwave radome lining layer.

11. The system of claim 1 wherein the partition unit comprises a planar thermally isolating radome window.

12. The system of claim 1 wherein the partition unit comprises a dome-shaped thermally isolating radome window.

13. (canceled)

14. The system of claim 1 wherein the target zone comprises an open-air zone for outdoor testing.

15. The system of claim 1 further comprising a condensation prevention unit operable to prevent condensation forming on the partition unit.

16. The system of claim 1 wherein the condensation prevention unit comprises a heating element configured to warm the partition unit.

17. The system of claim 1 wherein the condensation prevention unit comprises two concentric shells, between which a stream of hot air is introduced.

18. The system of claim 1 wherein the DUT chamber comprises a thermal chamber operable to maintain ambient temperatures between −40 Celsius and +125 Celsius.

19. The system of claim 1 wherein the DUT chamber comprises a thermal chamber and an openable lid wherein:
when in an open configuration, the lid is removed providing access to the thermal chamber;
when in a closed configuration, the lid presses against thermally resistant silicon pads.

20. The system of claim 1 wherein the thermal chamber is fluidly coupled to a thermal machine operable to cool or heat a temperature regulation fluid and to provide a stream of the temperature regulation fluid through the thermal chamber.

21-22. (canceled)

23. The system of claim 20 wherein the thermal machine further comprises a fluid pump and the stream of temperature regulation fluid is provided by pump action.

24. The system of claim 1 wherein the target zone comprises a chamber with inner walls lined with radio frequency absorbers.

25. (canceled)

26. The system of claim 1 wherein the test target comprises a point target.
